(19) United States
(12) Patent Application Publication
(10) Pub. No.: US 2011/0125070 A1
(43) Pub. Date: May 26, 2011

(54) Multifunction Recumbent Massage Bench

(76) Inventor: Fang-yu Lu, Sinwu Township (TW)

(21) Appl. No.: 12/624,573

(22) Filed: Nov. 24, 2009

(51) Int. Cl. A61H 15/00

(52) U.S. Cl. 601/115

(57) ABSTRACT

A multifunction massage bench includes a base frame and a bench mechanism. The bench mechanism is fixedly supported on the base frame and comprises a recumbent bench having a curved and convex top surface, a back massage assembly disposed under a first portion of the recumbent bench, a hip massage assembly disposed in a second portion of the recumbent bench, a foot massage assembly, and a head member. The back massage assembly comprises a first motor and rollers operatively actuated by the first motor so that the rollers repeatedly move upward and downward while rotating for performing a plurality of massage actions. The head member comprises a second motor for extending the head member outward to a predetermined distance so that the head of a person lying on the recumbent bench is disposed at an elevation slightly lower than that of the feet.

### BACKGROUND OF THE INVENTION

1. Field of Invention

The invention relates to massage equipment and more particularly to a multifunction recumbent massage bench with improved characteristics including a curved and convex top surface for a user to thoroughly stretch muscles and, thus, the multifunctional effect of massage, stretch and headstand-like posture is achieved via the multifunction recumbent massage bench.

2. Description of Related Art

A conventional type of massage machine is an L-shaped chair-like device. Another conventional type of massage machine is a flat bench so that a person may lie on the bench to massage parts of the body. However, either massage machine does not have features such as stretch (i.e., length adjustment) and the head of a user being able to place at an elevation slightly lower than the feet. Thus, the need for improvement still exists.

### SUMMARY OF THE INVENTION

It is therefore one object of the invention to provide a massage bench comprising a base frame and a bench mechanism. The bench mechanism is fixedly supported on the base frame and comprises a recumbent bench having a curved and convex top surface; the recumbent bench further has a convex and curved top surface, a back massage assembly disposed under a first portion of the recumbent bench, a hip massage assembly disposed in a second portion of the recumbent bench, a foot massage assembly, and a head member, wherein the back massage assembly comprises a first motor and a plurality of rollers operatively actuated by the first motor so that the rollers repeatedly move upward and downward while rotating for performing a plurality of massage actions; and the head member comprises a second motor for extending the head member outward to a predetermined distance so that the head of a person lying on the recumbent bench is disposed at an elevation slightly lower than the feet, thus, while lying on the massage bench, the muscles of a user are thoroughly stretched and pulled. The user can enjoy the benefit of massage, stretch and headstand-like posture.

In one aspect of the invention the bench mechanism further comprises two arm pads at both sides of the first portion of the recumbent bench respectively.

In another aspect of the invention the head member further comprises a head rest.

In a further aspect of the invention the hip massage assembly comprises a third motor for operative actuation of the hip massage assembly.

In a still further aspect of the invention the foot massage assembly comprises a fourth motor for operative actuation of the foot massage assembly.

In a yet further aspect of the invention the first portion of the recumbent bench is served to support the back and the hip portions thereof; and wherein the bench mechanism further comprises a length adjustment assembly between the head rest and the foot massage assembly for adjusting the length of the recumbent bench.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of multifunction recumbent massage bench according to the invention;

FIG. 2 is a perspective view of the frame of the multifunction recumbent massage bench with some components removed;

FIG. 3 is a side elevation of FIG. 2;

FIG. 4 is a view similar to FIG. 1 showing the back massage assembly in phantom;

FIG. 5 is a view similar to FIG. 1 showing a person lying on the recumbent bench to be massaged;

FIG. 6 is a side elevation of FIG. 5; and

FIG. 7 is a view similar to FIG. 6 showing the head at an elevation slightly lower than that of his feet in another massaging position

### DETAILED DESCRIPTION OF THE INVENTION

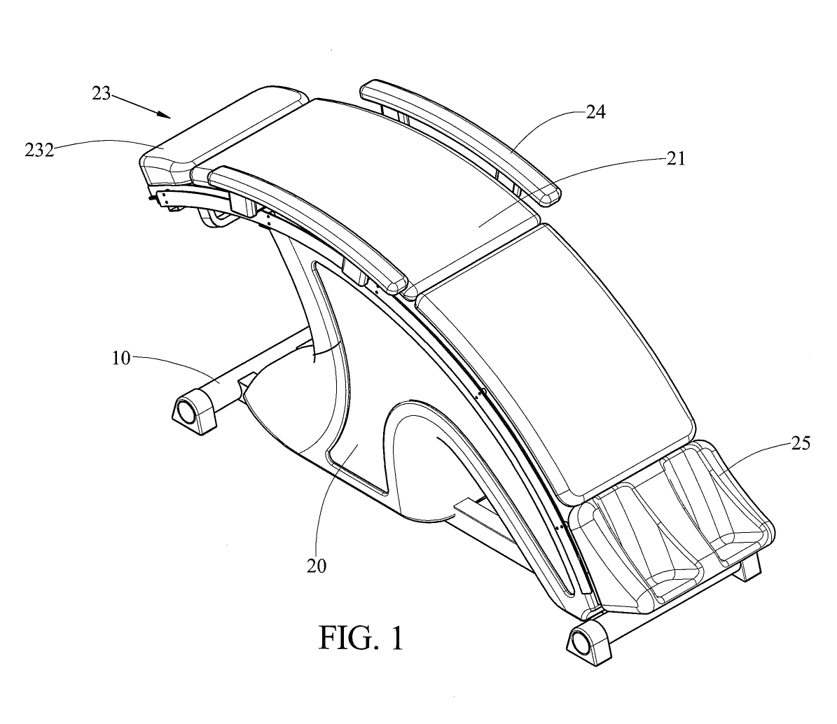

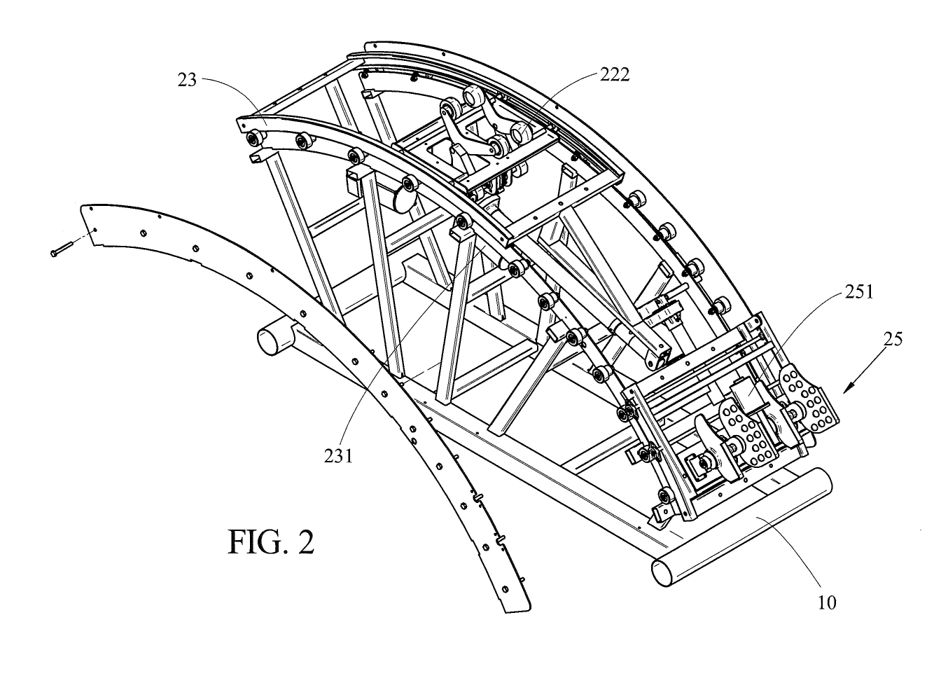

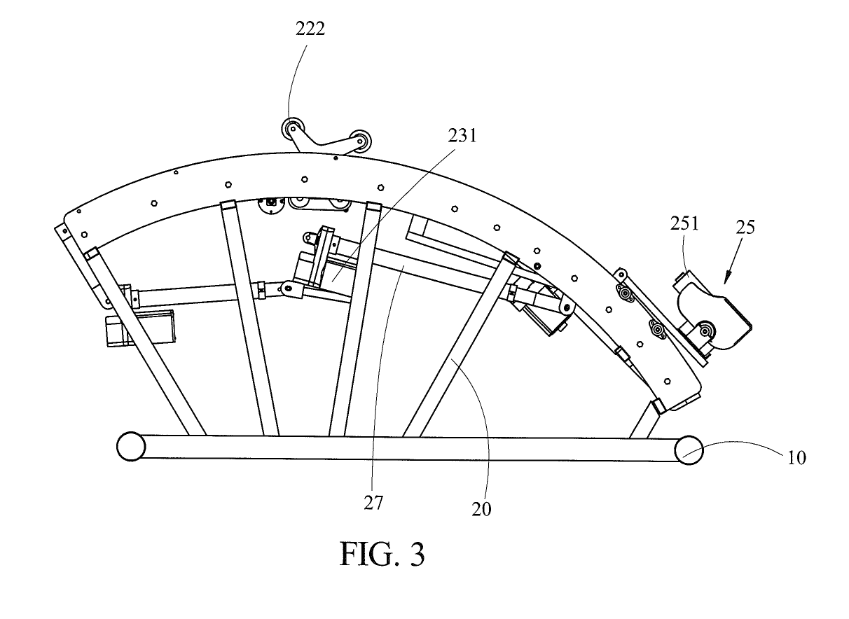

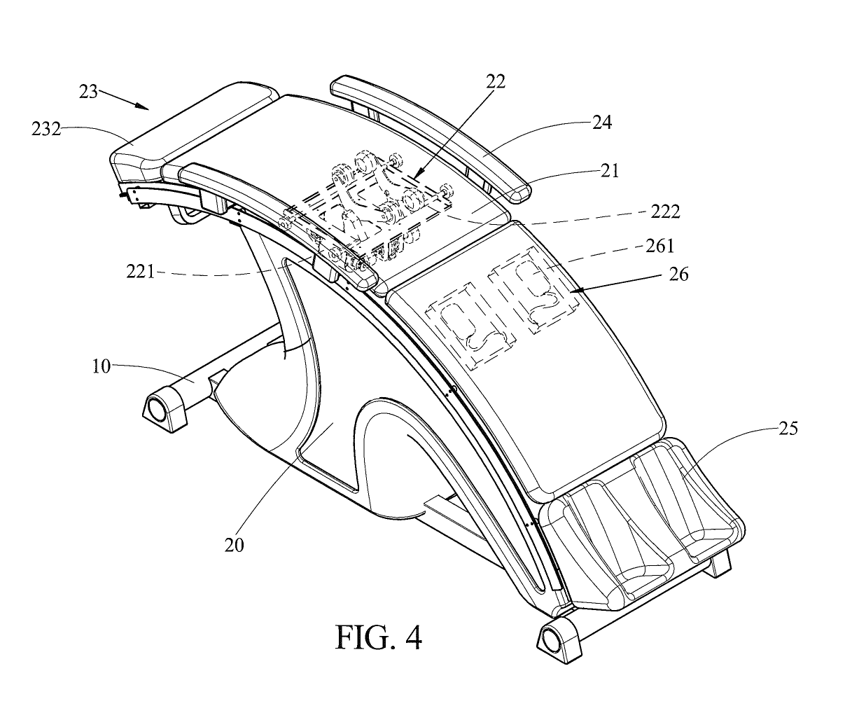

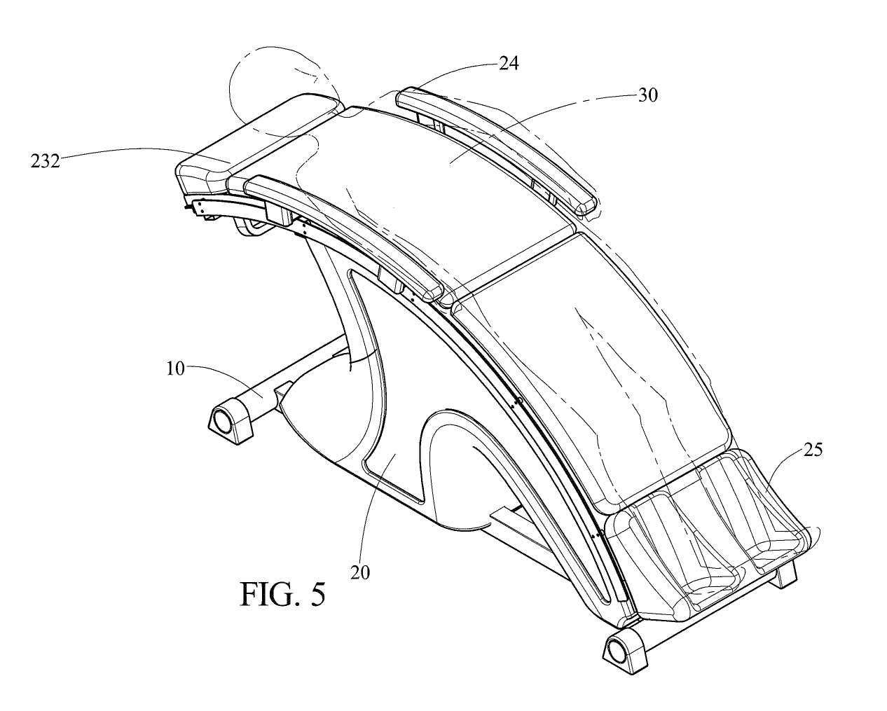

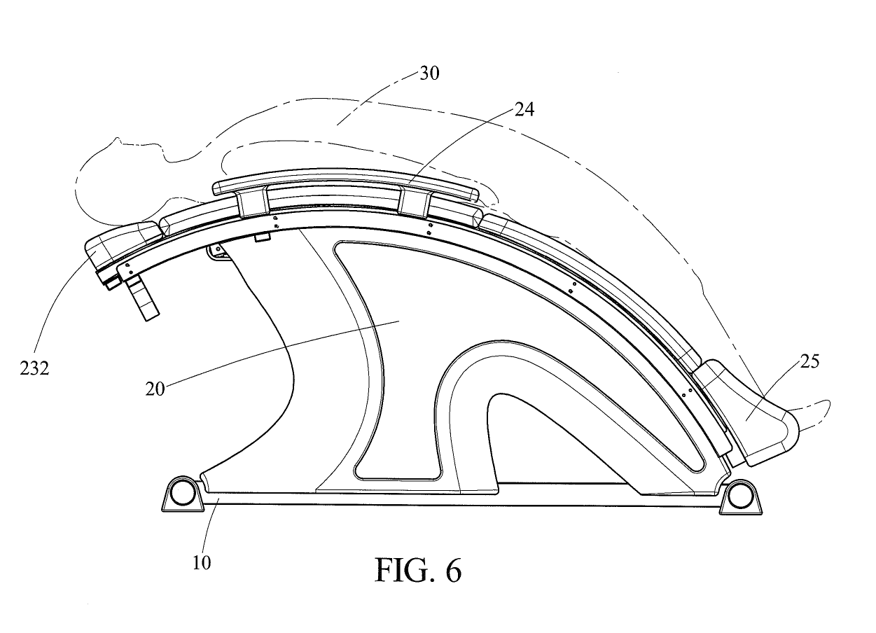

Referring to FIGS. 1 to 7, a multifunction recumbent massage bench in accordance with a preferred embodiment of the invention comprises a base frame 10 and a bench mechanism 20. Each of the above components will now be described in detail below.

The bench mechanism 20 is fixedly supported on the base frame 10 and comprises a recumbent bench 21 having a curved and convex surface, a back massage assembly 22 disposed under a first portion of the recumbent bench 21, at least one hip massage assembly 26 disposed in a second portion of the recumbent bench 21, a foot massage assembly 25, and a head member 23. The second portion of the recumbent bench 21 further comprises a cushion. Two hip massage assemblies 26 are mounted in the cushion.

The back massage assembly 22 comprises a first motor 221 and a plurality of rollers 222 operatively actuated by the first motor 221 so that the rollers 222 may repeatedly move upward and downward while rotating for performing actions such as rubbing, kneading, etc.

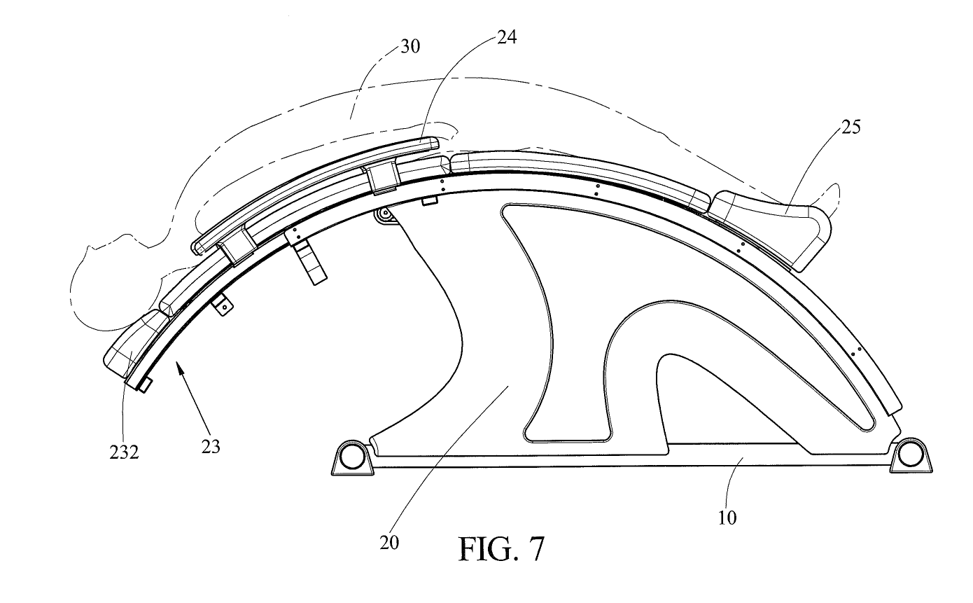

The head member 23 comprises at least a second motor 231 disposed under the rollers 222. The second motor 231 can be energized to extend the head member 23 outward to a predetermined distance so that the head of a person 30 lying on the recumbent bench 21 may be disposed at an elevation slightly lower than that of his feet. Therefore, the user 30 may be massaged, extends the head member 23 out of the back massage assembly 22 to a predetermined distance, and has his head to be at an elevation slightly lower than that of his feet (see FIG. 7).

The bench mechanism 20 has two arm pads 24 at both sides of the first portion of the recumbent bench 21 respectively.

The head member 23 further comprises a head rest 232.

The hip massage assembly 26 comprises a third motor 261 for operative actuation of the hip massage assembly.

The foot massage assembly 25 comprises a fourth motor 251 disposed therebelow for operative actuation of the foot massage assembly 25.

The first portion of the recumbent bench 21 is served to support the back of a user and the second portion thereof is served to support the hip.

The bench mechanism 20 further comprises a length adjustment assembly 27 between the head rest 232 and the foot massage assembly 25 for adjusting the length of the recumbent bench 21 in order to accommodate users of different heights and proportions.

The invention has the following advantages. The provision of the recumbent bench enables a person lying thereon in a comfortable manner. The provision of the head member enables the user to extend out of the bench at a predetermined distance so that the head can be disposed at an elevation slightly lower than that of his feet. Moreover, the massage bench can massage various parts of the body including the back, the hip, and the feet.

While the invention herein disclosed has been described by means of specific embodiments, numerous modifications and variations could be made thereto by those skilled in the art without departing from the scope and spirit of the invention set forth in the claims.

What is claimed is:

1. A massage bench comprising:
a base frame; and
a bench mechanism fixedly supported on the base frame and comprising a recumbent bench having a curved and convex top surface, a back massage assembly disposed under a first portion of the recumbent bench, a hip massage assembly disposed in a second portion of the recumbent bench, a foot massage assembly, and a head member,
wherein the back massage assembly comprises a first motor and a plurality of rollers operatively actuated by the first motor so that the rollers repeatedly move upward and downward while rotating for performing a plurality of massage actions; and
the head member comprises a second motor for extending the head member outward to a predetermined distance so that the head of a person lying on the recumbent bench is disposed at an elevation slightly lower than that of the feet.

2. The massage bench of claim 1, wherein the bench mechanism further comprises two arm pads at both sides of the first portion of the recumbent bench respectively.

3. The massage bench of claim 1, wherein the head member further comprises a head rest.

4. The massage bench of claim 1, wherein the hip massage assembly comprises a third motor for operative actuation of the hip massage assembly.

5. The massage bench of claim 1, wherein the foot massage assembly comprises a fourth motor for operative actuation of the foot massage assembly.

6. The massage bench of claim 3, wherein the first portion of the recumbent bench is served to support a user's back and the second portion thereof is served to support a user's hip; and wherein the bench mechanism further comprises a length adjustment assembly between the head rest and the foot massage assembly for adjusting length of the recumbent bench.
